(19) United States
(12) Patent Application Publication
(10) Pub. No.: US 2024/0020530 A1
(43) Pub. Date: Jan. 18, 2024

(54) LEARNING DEVICE, LEARNING METHOD AND PROGRAM

(71) Applicant: NIPPON TELEGRAPH AND TELEPHONE CORPORATION, Tokyo (JP)

(72) Inventors: Shinobu KUDO, Musashino-shi, Tokyo (JP); Ryuichi TANIDA, Musashino-shi, Tokyo (JP); Hideaki KIMATA, Musashino-shi, Tokyo (JP)

(73) Assignee: NIPPON TELEGRAPH AND TELEPHONE CORPORATION, Tokyo (JP)

(21) Appl. No.: 18/035,466

(22) PCT Filed: Nov. 10, 2020
(86) PCT No.: PCT/JP2020/041848

§ 371 Date: May 4, 2023

(51) Int. Cl. G06N 3/08; G06N 3/0455

(52) U.S. Cl. CPC G06N 3/08; G06N 3/0455

(57) ABSTRACT

According to an aspect of the present invention, there is provided a learning device including: a classification unit that classifies latent variables obtained from learning data used for learning into a label feature quantity and a non-label feature quantity; a decoding unit that decodes the label feature quantity and the non-label feature quantity classified by the classification unit by using decoder parameters to generate reconstruction data; and an optimization unit that optimizes the decoder parameters to minimize a classification error between the label feature quantity and label information used for classification by using the label feature quantity, and minimize a reconstruction error by using the label feature quantity and the non-label feature quantity.

### TECHNICAL FIELD

The present invention relates to a learning device, a learning method, and a program.

### BACKGROUND ART

There has been proposed a learning method in which two neural networks, which are We that extracts label features and Wu that extracts non-label features, are configured, the label features are further input into the neural network for class classification, and a classification task is solved. Then, in the proposed learning method, an input x is restored with a 1:1 weighted sum of reconstruction of the label features and reconstruction of the non-label features (for example, refer to Non Patent Literature 1).

### CITATION LIST

### Non Patent Literature

Non Patent Literature 1: Thomas Robert, Nicolas Thome, Matthieu Cord, “HybridNet:Classification and Reconstruction Cooperation for Semi-Supervised Learning”, 2018, retrieved on the Internet <URL:https://arxiv.org/abs/1807.11407>

### SUMMARY OF INVENTION

### Technical Problem

However, in the related art, when the class classification of the label features is solved, the features of the label features are further input into the NW for class classification, and thus, there is a possibility that information other than the class will disappear in this processing. Therefore, in the related art, even when the label features include information other than the class, the label features may not be able to be detected. As described above, in the related art, there is a problem that, since a feature may become lost at the time of learning, data may not be able to be clearly separated into a feature in some cases.

In view of the above circumstances, an object of the present invention is to provide a technology capable of clearly separating data into any feature.

### Solution to Problem

According to an aspect of the present invention, there is provided a learning device including: a classification unit that classifies latent variables obtained from learning data used for learning into a label feature quantity and a non-label feature quantity; a decoding unit that decodes the label feature quantity and the non-label feature quantity classified by the classification unit by using decoder parameters to generate reconstruction data; and an optimization unit that optimizes the decoder parameters to minimize a classification error between the label feature quantity and label information used for classification by using the label feature quantity, and minimize a reconstruction error by using the label feature quantity and the non-label feature quantity.

According to another aspect of the present invention, there is provided a learning method, in which a classification unit classifies latent variables obtained from learning data used for learning into a label feature quantity and a non-label feature quantity, a decoding unit decodes the label feature quantity and the non-label feature quantity classified by the classification unit by using decoder parameters to generate reconstruction data, and an optimization unit optimizes the decoder parameters to minimize a classification error between the label feature quantity and label information used for classification by using the label feature quantity, and minimize a reconstruction error by using the label feature quantity and the non-label feature quantity.

According to still another aspect of the present invention, there is provided program for causing a computer to classify latent variables obtained from learning data used for learning into a label feature quantity and a non-label feature quantity, decode the classified label feature quantity and non-label feature quantity by using decoder parameters to generate reconstruction data, and optimize the decoder parameters to minimize a classification error between the label feature quantity and label information used for classification by using the label feature quantity, and minimize a reconstruction error by using the label feature quantity and the non-label feature quantity.

### Advantageous Effects of Invention

According to the present invention, data can be clearly separated into any feature.

### BRIEF DESCRIPTION OF DRAWINGS

FIG. 1 is a diagram showing an example of a configuration of a learning device according to an embodiment.

FIG. 2 is a diagram showing an outline of processing of a first embodiment.

FIG. 3 is a flowchart showing a processing procedure example at the time of learning and at the time of classification according to the first embodiment.

FIG. 4 is a diagram showing an example of a label feature quantity and a non-label feature quantity according to the first embodiment.

FIG. 5 is a view showing an example of an original image and a reconstructed image according to the first embodiment.

FIG. 6 is a diagram showing an example of the original image and an image reconstructed when components other than the label feature quantity are exchanged, according to the first embodiment.

FIG. 7 is a diagram showing an outline of processing of a second embodiment.

FIG. 8 is a flowchart showing a processing procedure example at the time of learning and at the time of classification according to the second embodiment.

FIG. 9 is a diagram showing an example of a label feature quantity and a non-label feature quantity according to the second embodiment.

FIG. 10 is a view showing an example of an original image and a reconstructed image according to the second embodiment.

FIG. 11 is a diagram showing an example of the original image and an image reconstructed when components other than the label feature quantity are exchanged, according to the second embodiment.

FIG. 12 is a diagram showing an outline of processing of a third embodiment.

FIG. 13 is a flowchart showing a processing procedure example at the time of learning and at the time of classification according to the third embodiment.

FIG. 14 is a diagram showing an example of a label feature quantity and a non-label feature quantity in a case where processing of the second embodiment and processing of the third embodiment are performed in addition to the first embodiment.

FIG. 15 is a diagram showing an example of an original image in a case where processing of the second embodiment and processing of the third embodiment are performed in addition to the first embodiment, and a reconstructed image.

FIG. 16 is a diagram showing an example of an original image in a case where processing of the second embodiment and processing of the third embodiment are performed in addition to the first embodiment, and an image reconstructed when components other than the label feature quantity are exchanged.

### DESCRIPTION OF EMBODIMENTS

Embodiments of the present invention will be described in detail with reference to the drawings.

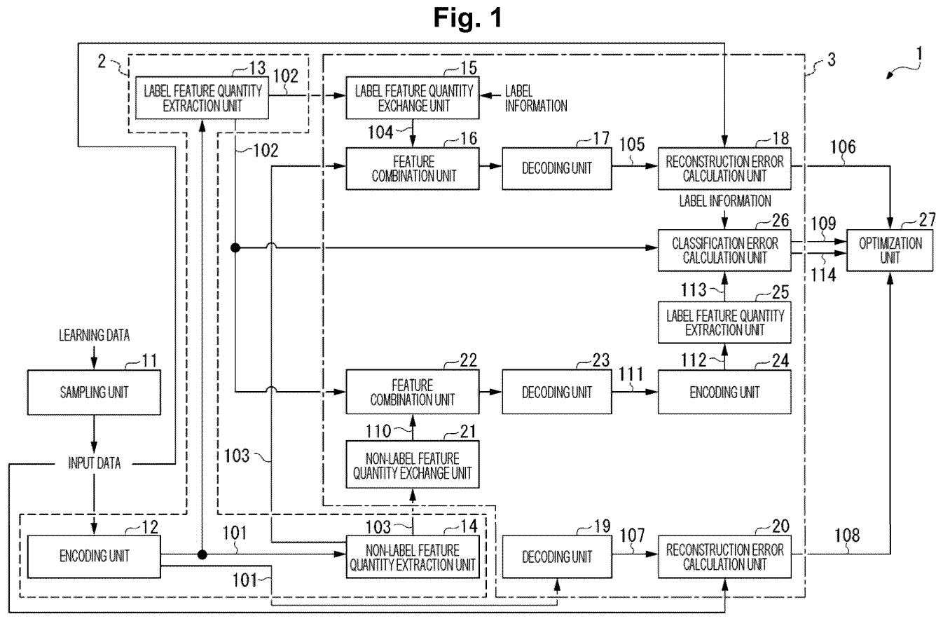

FIG. 1 is a diagram showing an example of a configuration of a learning device according to an embodiment. As shown in FIG. 1, a learning device 1 includes a sampling unit 11, a classification unit 2, a processing unit 3, and an optimization unit 27.

The classification unit 2 includes an encoding unit 12, a label feature quantity extraction unit 13, and a non-label feature quantity extraction unit 14.

The processing unit 3 includes a label feature quantity exchange unit 15, a feature combination unit 16, a decoding unit 17, a reconstruction error calculation unit 18, a decoding unit 19, a reconstruction error calculation unit 20, a non-label feature quantity exchange unit 21, a feature combination unit 22, a decoding unit 23, an encoding unit 24, a label feature quantity extraction unit 25, and a classification error calculation unit 26.

The learning device 1 separates input data into a label feature quantity and a non-label feature quantity. In the following description, the learning data is referred to as {xᵢ, yᵢ}, (xᵢ is input data, and yᵢ is label (class) information) (i=1, . . . , N).

The sampling unit 11 samples input data {x₁, y₁}, . . . , {x_{B}, y_{B}} of a batch size B (B is an integer of 1 or more) from the learning data {xᵢ, yᵢ}.

The encoding unit 12 encodes the sampled input data xᵢ to obtain a feature quantity 101 {Zᵢ=[z_{i,label}, z_{i,wo_label}]} including M parameters for each piece of data. Here, z_{i,label} is a label feature quantity z_{i,label}=[z_{i,1}, . . . , z_{i,C}] including C (C is an integer of 1 or more) parameters, and z_{i,wo_label} is a non-label feature quantity z_{i,wo_label}=[z_{i,C+1}, . . . , z_{i,M}] including M-C (M is an integer of 2 or more) parameters. The encoding unit 12 outputs the feature quantity 101 to the label feature quantity extraction unit 13, the non-label feature quantity extraction unit 14, and the decoding unit 19. Note that the latent variable is a feature quantity obtained by encoding in a case where an auto encoder is used.

The label feature quantity extraction unit 13 extracts a label feature quantity 102 {z_{i,label}}. The label feature quantity extraction unit 13 outputs the extracted label feature quantity 102 to the label feature quantity exchange unit 15, the feature combination unit 22, and the classification error calculation unit 26.

The non-label feature quantity extraction unit 14 extracts a non-label feature quantity 103 {z_{i,wo_label}}. The non-label feature quantity extraction unit 14 outputs the extracted non-label feature quantity 103 to the feature combination unit 16, the non-label feature quantity exchange unit 21, and the feature combination unit 22.

Label information assigned to the learning data and the label feature quantity 102 are input into the label feature quantity exchange unit 15. The label feature quantity exchange unit 15 randomly exchanges (swaps) each parameter of the label feature quantity z_{i,label} with the same label sample in the batch processing. The exchanged label feature quantity is referred to as (z_{i,label})^{swap}. The label feature quantity exchange unit 15 outputs the exchanged label feature quantity 104 to the feature combination unit 16. Note that the label feature quantity exchange unit 15 is not limited to batch processing, and there may be exchange with another sample of the same label.

The feature combination unit 16 combines the label feature quantity 104 exchanged by the label feature quantity exchange unit 15 and the non-label feature quantity 103 extracted by the non-label feature quantity extraction unit 14, and outputs the combined feature quantity to the decoding unit 17.

The decoding unit 17 decodes the feature quantity to obtain reconstruction data 105 {(xᵢ)^{(swap_label)\hat{ }}}. The decoding unit 17 outputs the reconstruction data 105 to the reconstruction error calculation unit 18.

The reconstruction error calculation unit 18 calculates a reconstruction error 106 {L_{rec,swap}} between the input data xᵢ and the reconstruction data (xᵢ)^{\hat{ }} obtained by decoding by the following formula (1). Note that, in Formula (1), d is any function that calculates the distance between the two vectors, and is, for example, the sum of mean square errors, the sum of mean absolute errors, or the like. The reconstruction error calculation unit 18 outputs the calculated reconstruction error 106 to the optimization unit 27.

$$\begin{matrix}[ Math . 1 ] & \\ {L}_{rec , swap} = \frac{1}{B} {\sum }_{i = 1}^{B} d ( {x}_{i} , ) & ( 1 )\end{matrix}$$

The decoding unit 19 decodes the feature quantity 101 to obtain reconstruction data 107 {(xᵢ)^{\hat{ }}}. The decoding unit 19 outputs the reconstruction data 107 to the reconstruction error calculation unit 20.

The reconstruction error calculation unit 20 calculates a reconstruction error 108 {L_{rec,org}} between the input data xᵢ and the reconstruction data (zᵢ)^{(swap_label)\hat{ }} output from the decoding unit 19 by the following formula (2).

$$\begin{matrix}[ Math . 2 ] & \\ {L}_{rec , org} = \frac{1}{B} {\sum }_{i = 1}^{B} d ( {x}_{i} , {\hat{x}}_{i} ) & ( 2 )\end{matrix}$$

The non-label feature quantity exchange unit 21 randomly exchanges each parameter of the non-label feature quantity z_{i,wo_label} with the sample in the batch processing. The exchanged label feature quantity is referred to as (z_{i,wo_label})^{swap}. The non-label feature quantity exchange unit 21 generates a feature quantity {(zᵢ)^{swap_wo_label}} obtained by combining the label feature quantity z_{i,label} and the exchanged (z_{i,wo_label)}^{swap}. The non-label feature quantity exchange unit 21 outputs the exchanged non-label feature quantity 110 to the feature combination unit 22.

The feature combination unit 22 combines the label feature quantity 102 extracted by the label feature quantity extraction unit 13 and the non-label feature quantity 110 exchanged by the non-label feature quantity exchange unit 21. The feature combination unit 22 outputs the combined feature quantity to the decoding unit 23.

The decoding unit 23 decodes the combined feature quantity {(zᵢ)^{swap_wo_label}} to obtain reconstruction data 111 {(xᵢ)^{(swap_wo_label)\hat{ }}}. The decoding unit 23 outputs the reconstruction data 111 to the encoding unit 24.

The encoding unit 24 re-encodes the reconstruction data 111 {(xᵢ)^{(swap_wo_label)\hat{ }}} to obtain the feature quantity 112. The encoding unit 24 outputs the feature quantity 112 to the label feature quantity extraction unit 25.

The label feature quantity extraction unit 25 extracts a label feature quantity {(z_{i,label})^{(swap_wo_label)\hat{ }}} from the feature quantity 112 and outputs the extracted label feature quantity 113 to the classification error calculation unit 26.

The label information, the label feature quantity 102 extracted by the label feature quantity extraction unit 13, and the label feature quantity 113 extracted by the label feature quantity extraction unit 25 are input into the classification error calculation unit 26. The classification error calculation unit 26 calculates a classification error 109 {L_{label,org}} from the label feature quantity 102 {z_{i,label}} by the following formula (3). In Formula (3), (z_{yi,label})⁻ is obtained by averaging the label feature quantity z_{i,label} of a sample of which label information is yᵢ in the batch sample, and K is the number of classification labels.

$$\begin{matrix}[ Math . 3 ] & \\ {L}_{label , org} = - \frac{1}{B} {\sum }_{i = 1}^{B} log \frac{{e}^{- d ( {z}_{i , label} , \overline{{z}_{{y}_{i ,} label}} )}}{{\sum }_{j = 1}^{K} {e}^{- d ( {z}_{i , label} , \overline{{z}_{{y}_{i ,} label}} )}} & ( 3 )\end{matrix}$$

In addition, the classification error calculation unit 26 calculates a classification error 114 {L_{label,swap}} from the label feature quantity 113 {(z_{i,label})^{(swap_wo_label)\hat{ }}} by the following formula (4).

$$\begin{matrix}[ Math . 4 ] & \\ {L}_{label , swap} = - \frac{1}{B} {\sum }_{i = 1}^{B} log \frac{{e}^{- d ( , \overline{{z}_{{y}_{i ,} label}} )}}{{\sum }_{j = 1}^{K} {e}^{- d ( , \overline{{z}_{{y}_{j ,} label}} )}} & ( 4 )\end{matrix}$$

The optimization unit 27 calculates an objective function L obtained by weighting each error by the following formula (5). Note that, in Formula (5), λ is a predetermined weighting coefficient.

[Math. 5]

L=λ₁L_{rec,org}+λ₂L_{rec,swap}+λ₃L_{label,org}+λ₄L_{label,swap} (5)

Furthermore, the optimization unit 27 updates the parameters of the encoding unit (12, 24) and the decoding unit (17, 19, 23) by, for example, a gradient method. For example, the optimization unit 27 determines whether or not the objective function L has converged, or determines whether or not a predetermined number of times of processing has ended.

Note that the configuration or processing shown in FIG. 1 is an example, and the configuration is not limited thereto. In addition, the configuration of FIG. 1 includes a functional unit to be used and a functional unit not to be used depending on the application. Furthermore, the encoding units 17, 19, and 23 may be integrated or may be separate. The feature combination units 18 and 22 may be integrated or separate. The reconstruction error calculation units 18 and 20 may be integrated or separate.

Note that the learning device 1 includes, for example, a processor such as a central processing unit (CPU) and a memory. The learning device 1 functions as the sampling unit 11, the encoding unit 2, the classification unit 3, and the optimization unit 27 by the processor executing a program. Note that all or some of each function of the learning device 1 may be implemented using hardware such as an application specific integrated circuit (ASIC), a programmable logic device (PLD), or a field programmable gate array (FPGA). The program may be recorded in a computer-readable recording medium. The computer-readable recording medium is, for example, a portable medium such as a flexible disk, a magneto-optical disc, a ROM, a CD-ROM, or a semiconductor storage device (for example, a solid state drive (SSD)), or a storage device such as a hard disk or a semiconductor storage device built into a computer system. The program may be transmitted via an electric communication line.

### First Example

In the present embodiment, the encoding unit 12 separates features on the same layer. In the present embodiment, exchange is not performed in the batch.

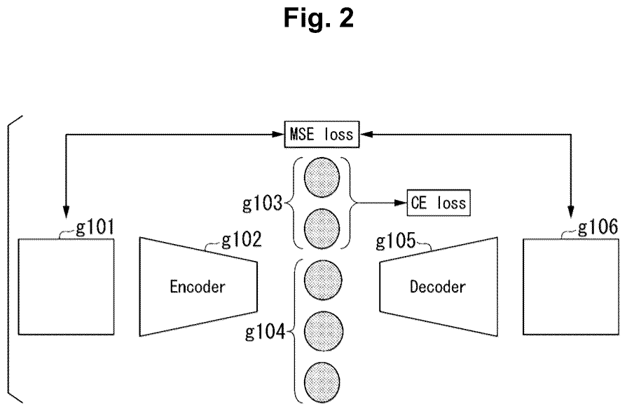

FIG. 2 is a diagram showing an outline of processing of the present embodiment. An encoder g102 corresponds to the encoding unit 12 in FIG. 1. The encoder g102 and a decoder g105 are, for example, auto encoders. Input data g101 is input into the encoder g102.

The learning device 1 performs learning by regarding a bottleneck part of an auto encoder as a feature.

The label feature quantity extraction unit 13 and the non-label feature quantity extraction unit 14 separate features into two, a label feature quantity g103 and a non-label feature quantity g104.

The label feature quantity g103 and the non-label feature quantity g104 are input into the decoder g105. The decoder g105 corresponds to the decoding unit 19 in FIG. 1.

The optimization unit 27 minimizes a class classification error (cross-entropy loss (CE loss)) by using the label feature quantity g103.

The optimization unit 27 minimizes the reconstruction error by using the label feature quantity g103 and the non-label feature quantity g104.

Next, processing procedure examples at the time of learning and at the time of classification will be described.

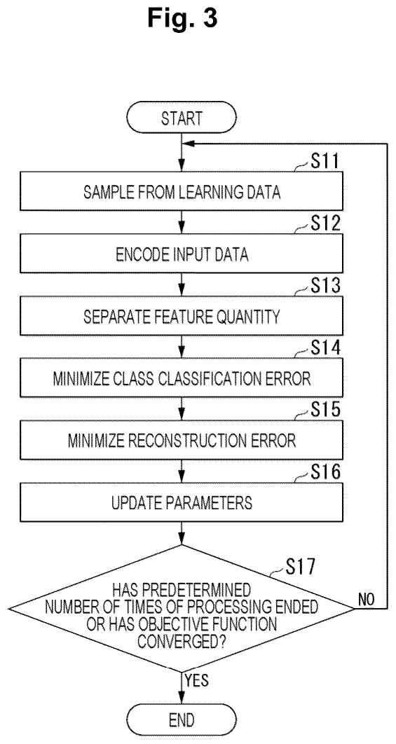

FIG. 3 is a flowchart showing a processing procedure example at the time of learning and at the time of classification according to the present embodiment.

The sampling unit 11 samples the input data of the batch size B from the learning data (step S11). The encoding unit 12 encodes the input data to obtain a feature quantity (step S12).

The label feature quantity extraction unit 13 extracts the label feature quantity, and the non-label feature quantity extraction unit 14 extracts the non-label feature quantity to separate the feature quantity into two (step S13).

The optimization unit 27 minimizes the class classification error by using the label feature quantity g103 (step S14). The optimization unit 27 minimizes the reconstruction error by using the label feature quantity g103 and the non-label feature quantity g104 (step S15).

The optimization unit 27 updates the parameters of the encoding unit (12, 24) and the decoding unit (17, 19, 23) by, for example, a gradient method (step S16). For example, the optimization unit 27 determines whether or not the objective function L has converged, or determines whether or not a predetermined number of times of processing has ended (step S16). The optimization unit 27 ends the process in a case where the objective function L has converged or in a case where the predetermined number of times of processing has ended (step S17; YES). The optimization unit 27 repeats the processing of steps S11 to S16 in a case where the objective function L has not converged or in a case where the predetermined number of times of processing has not ended (step S17; NO).

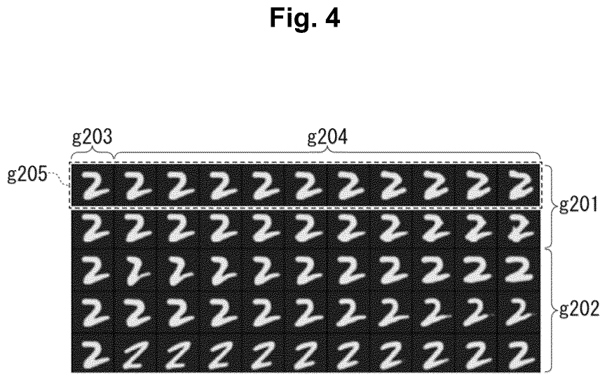

Next, an example showing the effect of the present embodiment is shown in FIGS. 4 to 6. In FIGS. 4 to 6, learning data and data to be classified are examples of image data. In addition, the label feature quantity is a number type (0 to 9), and the non-label feature quantity is a number shape.

FIG. 4 is a diagram showing an example of a label feature quantity and a non-label feature quantity according to the present embodiment. The vertical axis represents a label feature quantity g201 and a non-label feature quantity g202. In the horizontal direction, an original image g203 and an image g204 reconstructed when the features are respectively changed are shown. Note that the image in the frame g205 will be described later.

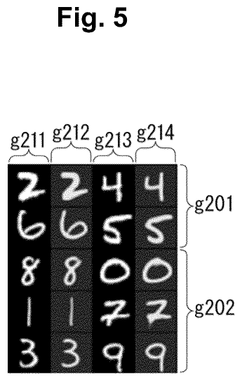

FIG. 5 is a diagram showing an example of an original image and a reconstructed image according to the present embodiment. In the horizontal direction, original images g211 and g213 and reconstructed images g212 and g214 are shown.

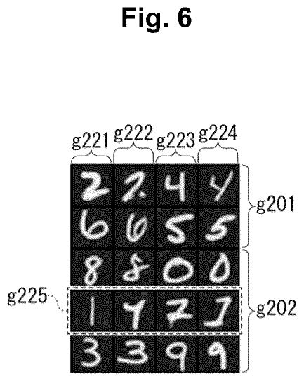

FIG. 6 is a diagram showing an example of the original image and an image reconstructed when components other than the label feature quantity are exchanged, according to the present embodiment. In the horizontal direction, the original images g221 and g223 and the images g212 and g214 reconstructed when components other than the label feature quantity are exchanged are shown. Note that the image in a frame g225 will be described later.

In the present embodiment, in the learning device 1 configured as described above, the features are separated into two, the label feature and the non-label feature. In addition, in the learning device 1, the class classification error is minimized by using the label feature quantity. In addition, in the learning device 1, the reconstruction error is minimized by using the label feature quantity and the non-label feature quantity.

Thus, according to the present embodiment, since the reconstruction is performed by the auto encoder, there is no feature leakage. In addition, according to the present embodiment, label information can be clearly extracted as a representation on a continuous space.

### Second Example

A technique for more accurately excluding label features from non-label features will be described in the present embodiment. When a label feature is included in a non-label feature, an output value obtained as a result of decoding is considered to be an output value of a different label. In addition, in the case of data having the same label, even when non-label features are exchanged, the output values are decoded into the same class. Therefore, in the present embodiment, the learning device 1 performs learning by exchanging non-label features in a batch.

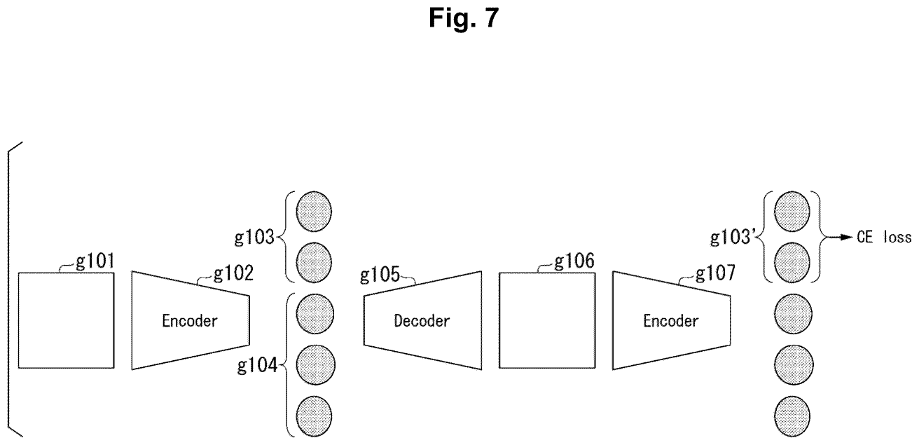

FIG. 7 is a diagram showing an outline of processing of the present embodiment. An encoder g107 corresponds to the encoding unit 24 in FIG. 1. The encoder g107 is, for example, an auto encoder. Reconstructed data g106 is input into the encoder g107. Note that the encoder g102 and the encoder g107 may be integrated or separate.

In the second embodiment, in addition to the first embodiment, the following processing is performed.

The non-label feature quantity exchange unit 21 exchanges the non-label feature quantity between batches.

The decoding unit 23 decodes a feature quantity obtained by combining the label feature quantity and the exchanged non-label feature quantity.

The encoding unit 24 re-encodes the decoded feature quantity.

The optimization unit 27 minimizes the class classification error by using a label feature quantity g103′ obtained as a result of the re-encoding.

Next, processing procedure examples at the time of learning and at the time of classification will be described.

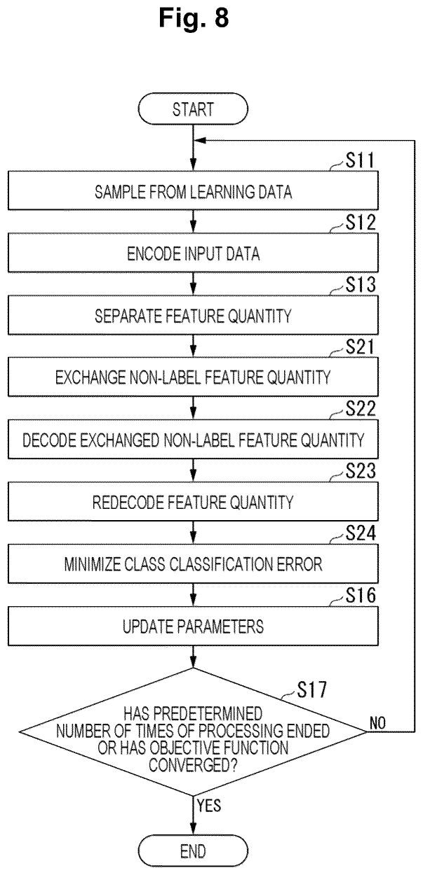

FIG. 8 is a flowchart showing a processing procedure example at the time of learning and at the time of classification according to the present embodiment.

The learning device 1 performs processing of steps S11 to S13.

Subsequently, the non-label feature quantity exchange unit 21 exchanges the non-label feature quantity between batches (step S21). The decoding unit 23 decodes a feature quantity obtained by combining the label feature quantity and the exchanged non-label feature quantity (step S22). The encoding unit 24 re-encodes the decoded feature quantity (step S23).

Subsequently, the optimization unit 27 minimizes the class classification error by using the re-encoded label feature quantity g103′ (step S24).

Subsequently, the learning device 1 performs processing of steps S16 to S17.

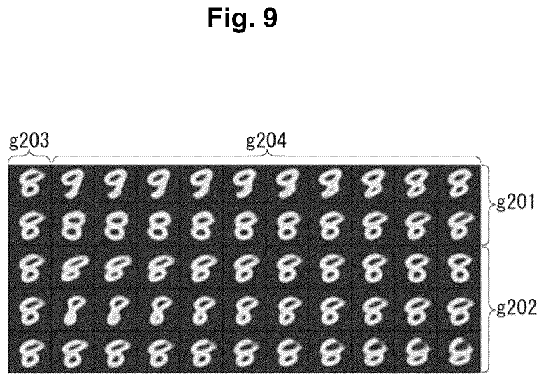

Next, an example showing the effect of the present embodiment is illustrated in FIGS. 9 to 11. In FIGS. 9 to 11, learning data and data to be classified are examples of image data.

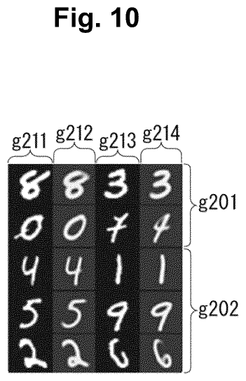

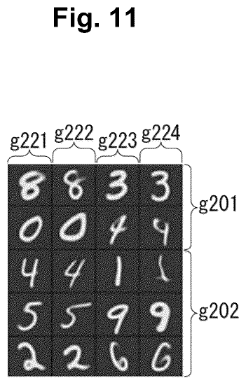

FIG. 9 is a diagram showing an example of a label feature quantity and a non-label feature quantity according to the present embodiment. FIG. 10 is a diagram showing an example of an original image and a reconstructed image according to the present embodiment. FIG. 11 is a diagram showing an example of the original image and the image reconstructed when components other than the label feature quantity are exchanged according to the present embodiment.

Even when the non-label feature quantity is exchanged and reconstructed as shown in FIG. 11, the feature quantity does not change to other numbers, that is, the label information is not included in the non-label feature quantity.

In the present embodiment, in the learning device 1 configured as described above, the features are separated into two, the label feature and the non-label feature. In addition, in the learning device 1, the non-label feature quantity is exchanged between batches. In addition, in the learning device 1, the exchanged data is decoded and the decoded reconstruction data is re-encoded. In addition, the learning device 1 minimizes the class classification error by using the label feature quantity g103′ obtained by re-encoding.

When label information is included in non-label feature, the data may be data of different labels when reconstructed. On the other hand, according to the present embodiment, by re-encoding the reconstructed image to reduce the class classification error, it is possible to prevent the label information from being included in the non-label feature.

### Third Example

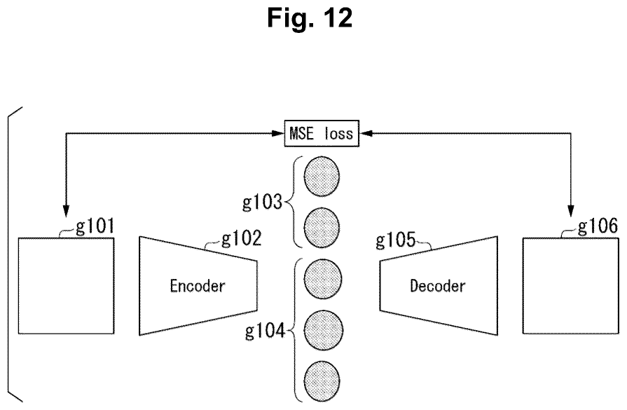

A technique of further removing information other than the label feature quantity from the label feature quantity will be described in the present embodiment. As long as data to which the same label is assigned is exchanged, classes obtained as a result of decoding are the same even when label features are exchanged. Therefore, in the present embodiment, the learning device 1 performs learning by exchanging label features between the same labels in a batch. FIG. 12 is a diagram showing an outline of processing of the present embodiment.

In the third embodiment, in addition to the first embodiment, the following processing is performed.

The label feature quantity exchange unit 15 randomly exchanges the label feature quantity between the same labels in the batch.

The decoding unit 17 decodes a feature quantity obtained by combining the exchanged label feature quantity and the non-label feature quantity.

The optimization unit 27 minimizes a reconstruction error by using the reconstruction data decoded by the decoding unit 17.

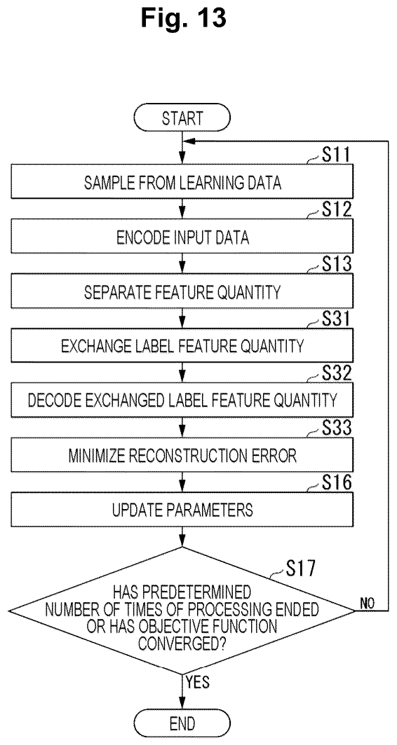

Next, first processing procedure examples at the time of learning and at the time of classification in a case where the processing of the present embodiment is performed in addition to the first embodiment will be described. FIG. 13 is a flowchart showing a processing procedure example at the time of learning and at the time of classification according to the third embodiment.

The learning device 1 performs processing of steps S11 to S13.

The label feature quantity exchange unit 15 randomly exchanges the label feature quantity g103 between the same labels in the batch (step S31). The decoding unit 17 decodes a feature quantity obtained by combining the exchanged label feature quantity g103 and the non-label feature quantity g104 (step S32).

The optimization unit 27 minimizes a reconstruction error by using the exchanged and decoded reconstruction data (step S33).

The learning device 1 performs processing of steps S16 to S17.

In the present embodiment, in the learning device 1 configured as described above, the features are separated into two, the label feature and the non-label feature. In addition, in the learning device 1, the label feature quantity is exchanged between the same labels in a batch. In addition, the learning device 1 decodes the exchanged data, and minimizes the reconstruction error by using the decoded reconstruction data.

As described above, according to the present embodiment, the label feature quantity is exchanged with other same label data and reconstructed. In this reconstruction, since only the label information needs to be included in the exchanged label feature quantity, non-label information can be prevented from being included in the label feature quantity.

Note that, according to the present embodiment, it is possible to extract a common feature between exchanged samples. In the present embodiment, learning data without label information is divided into two features (first partial feature quantity (label feature quantity) and second partial feature quantity (non-label feature quantity)), and label feature quantity is randomly exchanged to calculate a reconstruction error, and thus a latent common feature of the learning data can be obtained. Note that, as the common feature, for example, in the case of an image group of dogs, information of a dog is a common feature, in the case of an image group of handwritten characters of a certain person, information of how the person writes is a common feature, or in the case of learning data of a natural image such as Imagenet which is a data set, a concept of a natural image is a common feature. As a result, the present embodiment can also be applied to learning data to which no label is assigned.

In the processing in this case, for example, the learning device 1 extracts a feature quantity from target data, reconstructs the extracted feature quantity to acquire reconstruction data, and outputs a reconstruction error that is a difference between the target data and the reconstruction data as a degree to which the target data has a feature commonly included in a predetermined data group. At the time of reconstruction, the learning device 1 separates the feature quantity obtained from data belonging to a predetermined data group into the first partial feature quantity and the second partial feature quantity, exchanges the second partial feature quantity with a second partial feature quantity extracted from another piece of data belonging to a predetermined data group, and acquires a post-exchange feature quantity. Then, the learning device 1 performs optimization such that a difference between data obtained by reconstructing the post-exchange feature quantity and data belonging to a predetermined data group becomes small.

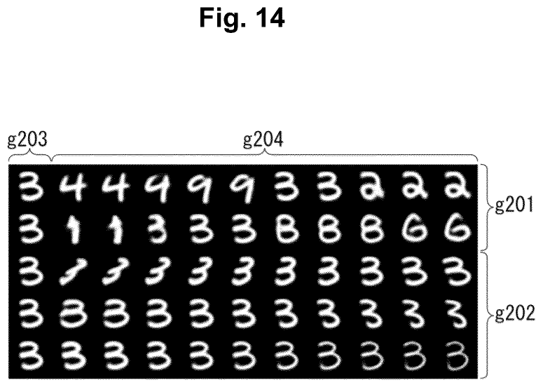

Next, an example of effects in a case where processing of the second embodiment and processing of the present embodiment are performed in addition to the first embodiment is shown in FIGS. 14 to 16. In FIGS. 14 to 16, learning data and data to be classified are examples of image data.

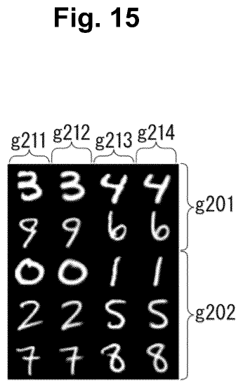

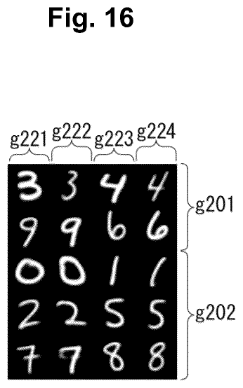

FIG. 14 is a diagram showing an example of a label feature quantity and a non-label feature quantity in a case where processing of the second embodiment and processing of the present embodiment are performed in addition to the first embodiment. FIG. 15 is a diagram showing an example of an original image in a case where processing of the second embodiment and processing of the present embodiment are performed in addition to the first embodiment, and a reconstructed image. FIG. 16 is a diagram showing an example of an original image in a case where processing of the second embodiment and processing of the present embodiment are performed in addition to the first embodiment, and an image reconstructed when components other than the label feature quantity are exchanged.

As shown in FIGS. 14 to 16, in a case where the processing of the second embodiment is performed in addition to the processing of the first embodiment, label information is not added to the non-label feature. In addition, in a case where the processing of the present embodiment is performed in addition to the first embodiment, information other than the label feature is not added to the label feature quantity. As a result, according to the second embodiment and the present embodiment, it is possible to clearly separate the label information and the non-label information

### Modification Example

Note that, in each of the above-described examples, the target data for separating the features is not limited to the image data, and may be other data. The image data may be a still image or a moving image.

In addition, according to each of the above-described embodiments, since data can be separated into any feature, data having a specific feature can be generated, or a specific feature can be edited and reconstructed. As a result, each of the above-described embodiments can generate and edit data on any feature (disentanglement of data).

In addition, according to each of the above-described embodiment, since the label information and the other information can be separated, and the label information can be further extracted as a value in the continuous space, application to recognition of an unlearned class and the like is possible. As a result, each of the above-described embodiments can improve the accuracy of Few-shot learning for recognizing the class of the minority data.

In normal transfer learning, features specialized for a class classification task, such as learning with the Imagenet class classification problem, are reused. However, there is a possibility that information necessary for another task is lost. On the other hand, according to each of the above-described embodiment, since features are obtained without excess or deficiency in order to reproduce data, necessary information is not lost even when transfer learning is performed to various tasks, and thus accuracy can be improved. As a result, each of the above-described embodiments can improve the accuracy of transfer learning.

Although the embodiments of the present invention have been described in detail with reference to the drawings, specific configurations are not limited to the embodiments, and include design and the like within the scope of the present invention without departing from the gist of the present invention.

### INDUSTRIAL APPLICABILITY

The present invention is applicable to separation of features of data, generation of data, editing of data, recognition of a class of data, transfer learning, and the like.

### REFERENCE SIGNS LIST

1 Learning device
2 Classification unit
3 Processing unit
11 Sampling unit
12 Encoding unit
13 Label feature quantity extraction unit
14 Non-label feature quantity extraction unit
15 Label feature quantity exchange unit
16 Feature combination unit
17 Decoding unit
18 Reconstruction error calculation unit
19 Decoding unit
20 Reconstruction error calculation unit
21 Non-label feature quantity exchange unit
22 Feature combination unit
23 Decoding unit
24 Encoding unit
25 Label feature quantity extraction unit
26 Classification error calculation unit
27 Optimization unit

1. A learning device comprising:
a processor; and
a storage medium having computer program instructions stored thereon, when executed by the processor, perform to:
classifies latent variables obtained from learning data used for learning into a label feature quantity and a non-label feature quantity;
decodes the label feature quantity and the non-label feature quantity classified by using decoder parameters to generate reconstruction data; and
optimizes the decoder parameters to minimize a classification error between the label feature quantity and label information used for classification by using the label feature quantity, and minimize a reconstruction error by using the label feature quantity and the non-label feature quantity.

2. The learning device according to claim 1, wherein the non-label feature quantity includes M-C (C is an integer of 1 or more and M is an integer of 2 or more) parameters, and
wherein the computer program instructions further perform to
randomly exchanges each parameter of the non-label feature quantity with the learning data in batch processing;
combines the exchanged non-label feature quantity and the label feature quantity;
generates a feature quantity by encoding the reconstruction data generated by decoding the combined feature quantity;
extracts a label feature quantity from the feature quantity; and
calculates the classification error by using the label feature quantity, and
minimizes the classification error by using the label feature quantity.

3. The learning device according to claim 1 unit includes an auto encoder.

4. The learning device according to claim 2, wherein
the classification error is a value represented by L_{label,swap} in the following formula,
$${L}_{label , swap} = - \frac{1}{B} {\sum }_{i = 1}^{B} log \frac{{e}^{- d ( , \overline{{z}_{{y}_{i ,} label}} )}}{{\sum }_{j = 1}^{K} {e}^{- d ( , \overline{{z}_{{y}_{j ,} label}} )}} \qquad [ Math . 1 ]$$
where the (z_{yi,label})⁻ is obtained by averaging a label feature quantity z_{i,label} of a sample of which label information is yᵢ among batch samples, the K is the number of classification labels, the (z_{i,label})^{(swap_wo_label)\hat{ }} is a label feature quantity obtained by encoding the reconstruction data, B (B is an integer of 1 or more) is a batch size, and the d is any function that calculates a distance between two vectors.

5. A learning method, wherein
a classification unit classifies latent variables obtained from learning data used for learning into a label feature quantity and a non-label feature quantity,
a decoding unit decodes the label feature quantity and the non-label feature quantity classified by the classification unit by using decoder parameters to generate reconstruction data, and
an optimization unit optimizes the decoder parameters to minimize a classification error between the label feature quantity and label information used for classification by using the label feature quantity, and minimize a reconstruction error by using the label feature quantity and the non-label feature quantity.

6. A non-transitory computer-readable medium having computer-executable instructions that, upon execution of the instructions by a processor of a computer, cause the computer to
classify latent variables obtained from learning data used for learning into a label feature quantity and a non-label feature quantity,
decode the classified label feature quantity and non-label feature quantity by using decoder parameters to generate reconstruction data, and
optimize the decoder parameters to minimize a classification error between the label feature quantity and label information used for classification by using the label feature quantity, and minimize a reconstruction error by using the label feature quantity and the non-label feature quantity.
